(19) United States
(12) Patent Application Publication
(10) Pub. No.: US 2014/0323215 A1
(43) Pub. Date: Oct. 30, 2014

(54) METHOD, TERMINAL, SERVER AND RECORDING MEDIUM FOR PROVIDING GAME SERVICE

(71) Applicants: Intellectual Discovery Co., Ltd., Seoul (KR); NEOWIZ GAMES CORPORATION, Seongnam-si (KR)

(72) Inventor: Woo Youl LIM, Yongin-si (KR)

(73) Assignees: Intellectual Discovery Co., Ltd., Seoul (KR); NEOWIZ GAMES CORPORATION, Seongnam-si (KR)

(21) Appl. No.: 14/264,349

(22) Filed: Apr. 29, 2014

(30) Foreign Application Priority Data
Apr. 29, 2013 (KR) 10-2013-0047204

(51) Int. Cl. A63F 13/00

(52) U.S. Cl. CPC A63F 13/00
USPC 463/31

(57) ABSTRACT

A method, a terminal, a server, and a recording medium for providing a game service includes generating an event in which a game stop request event is generated by a terminal, controlling a display in which inquiry information for game control of the terminal is controlled to be displayed to correspond to the game stop request event, and controlling a game in which a game of the terminal is controlled based on manipulation information corresponding to the inquiry information.

### CROSS-REFERENCE TO RELATED APPLICATION

This application claims priority to and the benefit of Korean Patent Application No. 10-2013-0047204 filed in the Korean Intellectual Property Office on Apr. 29, 2013, the entire content of which is incorporated herein by reference.

### BACKGROUND OF THE INVENTION

(a) Field of the Invention

A technique for providing a game service is provided.

(b) Description of the Related Art

In recent times, game industries have largely grown due to infrastructure expansion such as the increase of home PCs, activated LAN gaming centers, extensive usage of inexpensive high-speed communications networks.

Games are typically divided into arcade games, video games that are used by being connected to TV at home, games for portable devices, computer games that are used in computers, online games that are executed through networks, and the like. Particularly, the online games are a kind of network games using the Internet having no space restraints, which tens of thousands of game users can use with many other game users through specific scenarios.

However, in such online games, whether to access to the games completely depends on the game users, and game service providers have no means for preventing disconnection of game users. Accordingly, it is necessary to develop a means for persuading the game users who are about to quit the games to change their minds and to continue playing the games.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment provides a method for providing a game service, including: generating an event in which a game stop request event is generated by a terminal, controlling a display in which inquiry information for game control of the terminal is controlled to be displayed to correspond to the game stop request event, and controlling a game in which a game of the terminal is controlled based on manipulation information corresponding to the inquiry information.

The inquiry information corresponding to user information of the terminal may include pop-up contents information that is set by a server or a user input.

The pop-up contents information may be generated based on at least one of performance history information of the game or social information of the game.

Before generating the event, a pop-up setting step in which a pop-up setting interface is controlled to be displayed to enable a user to select an item to be displayed as the pop-up contents information may be included.

In controlling the display, the pop-up contents information may be controlled to be displayed on the terminal of a user selected according to a predetermined pop-up display reference.

An exemplary embodiment provides a server providing a game service, including: an event receiver configured to receive a game stop request event that is generated by a terminal; a display controller configured to control inquiry information for game control of the terminal to be displayed to correspond to the received game stop request event; and a game controller configured to receive manipulation information corresponding to the inquiry information from the terminal to control a game of the terminal.

An exemplary embodiment provides a method for providing a game service, including: generating an event in which a game stop request event that is generated according to a user manipulation is transmitted to a server; controlling a display in which inquiry information for game control corresponding to the game stop request event is controlled to be displayed when the inquiry information is inputted; and controlling a game in which a game is controlled based on manipulation information that is inputted to correspond to the inquiry information.

An exemplary embodiment provides a terminal for providing a game service, including: an event transmitter configured to transmit a game stop request event that is generated according to a user manipulation to a server; a display controller configured to control inquiry information for game control corresponding to the game stop request event to be displayed when the inquiry information is inputted; and a game controller configured to control a game based on manipulation information that is inputted to correspond to the inquiry information.

As described above, in accordance the exemplary embodiments, it may provide an effect of improving an interest of a game user in the game by displaying information related to curiosity of the game user when an event for quitting the game is generated.

Further, it is possible to provide another effect of persuading a user who is desired to quit the game to continue playing the game a little more by supplying information that may stimulate the user to continue playing the game, thereby increasing a game usage time of the user or preventing game stop of the user.

### BRIEF DESCRIPTION OF THE DRAWINGS

FIG. 1 is a schematic diagram showing the structure of a system for providing a game service in accordance with an exemplary embodiment.

FIG. 2 is a flowchart shown a method for providing a game service in accordance with the present exemplary embodiment.

FIG. 3 is a block diagram showing the structure of a server for providing a game service in accordance with the present exemplary embodiment.

FIG. 4 is a block diagram showing the structure of a server for providing a game service in accordance with another exemplary embodiment.

FIG. 5 is a block diagram showing the structure of a terminal for providing a game service in accordance with the present exemplary embodiment.

FIG. 6 to FIG. 8B are exemplary diagrams showing the method for providing a game service in accordance with the present exemplary embodiment.

### DETAILED DESCRIPTION OF THE EMBODIMENTS

The features of the present invention are to control inquiry information for game control of a terminal to be displayed to correspond to a game stop request event that is generated by the terminal, and control a game based on manipulation information corresponding to the inquiry information.

Hereinafter, some exemplary embodiments in the present specification will be described in detail with reference to the illustrative drawings. In adding reference numerals to components of each drawing, even though the same components are illustrated in different drawings, it is to be noted that these components are denoted by the same reference numerals if possible. In describing exemplary embodiments of the present invention, well-known functions or constructions will not be described in detail since they may unnecessarily obscure the understanding of the present invention.

In addition, in describing components of the present specification, terms such as first, second, A, B, (a), and (b) may be used. These terms are used only to differentiate the components from other components, but the nature, sequence, order, etc. of the corresponding components are not limited by these terms. When a component is “connected”, “coupled”, or “linked” to another component, it is to be noted that the component may be directly connected or linked to the another component, but the component may be “connected”, “coupled”, or “linked” to the another component via another component therebetween.

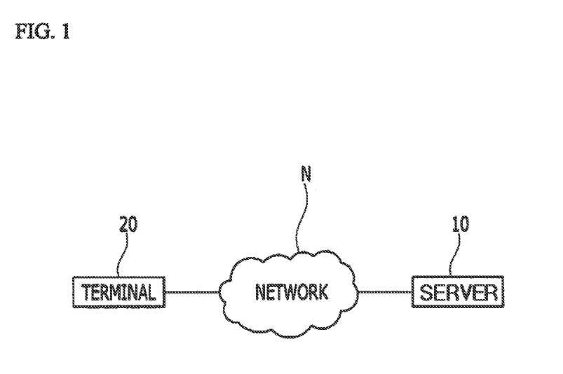

FIG. 1 is a schematic diagram showing the structure of a system for providing a game service in accordance with an exemplary embodiment.

Referring to FIG. 1, the system for providing a game service in accordance with the present exemplary embodiment includes a terminal 20 for executing a game according to the manipulation of a user, and a server 10 which is connected to the terminal 20 to transmit and receive data to enable the terminal to execute the game and, when receiving a game stop request event, transmit corresponding inquiry information to display it on the terminal 20.

Such game services which are provided in embodiments are applicable to any game through which users can transmit and receive data to and from other users and of which executions can be quitted by the manipulation of the users regardless of game genres or types such as role playing games (RPG), simulation games, arcade games, and shooting games.

The server 10 may control the performance of a game based on data transmitted from each terminal 20 and transmit the result to the terminals 20. Further, if necessary, the server 10 may relay data that is transmitted and received between the terminals 20.

The terminal 20 is a device which receives a game service and executes a game, and may include not only a general PC such as a typical desktop and a laptop but also a mobile terminal such as a smart phone, a tablet PC, personal digital assistants (PDAs), and a mobile communication terminal

However, the terminal 20 is not limited thereto, but may include any electronic device that can execute a game according to the manipulation of users.

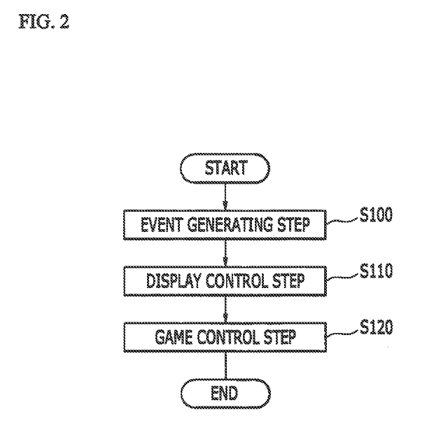

Considering a hardware construction, the server 10 has the same configuration as a general web server, a web application server, or WAP server. However, as will be described below with reference to FIG. 2, considering a software construction, the server 10 includes a program module which is implemented by other languages such as C, C++, Java, Visual Basic, and Visual C and executes various functions.

The server 10 may indicate a computer system which is generally connected to a plurality of unspecified clients (including terminals 20) and/or other servers via a network N such as the Internet, receives a job execution request from the clients or other web servers, and derives and provides job results therefor, and computer software (server program) installed therefor.

Further, in addition to the above-mentioned server programs, the server 10 is to be understood as a broad concept including a series of application programs executed on the server 10 and in some cases, various types of databases (hereinafter, referred to as “DB”) which are constructed inside or outside.

The server 10 may store contents, various information, and data in a database to manage them. Herein, the database may be embodied inside or outside the server 10.

Further, the server 10 may be implemented using the server programs which are variously provided depending on operating systems such as DOS, windows, Linux, UNIX, and Macintosh in hardware for a general server and as the representative server programs, a website and an internet information server (IIS) used in the windows environment and Apache, Nginx, Light HTTP, etc., used in the UNIX environment, and the like may be used

The network N is a network which connects the server 10 to the terminals 20 and may be a closed network such as a local area network (LAN) and a wide area network (WAN) but may be an opened network such as Internet. Herein, the Internet indicates universal opened computer network architecture which provides a TCP/IP protocol and several services existing on the upper layer, that is, a hypertext transfer protocol (HTTP), Telnet, a file transfer protocol (FTP), a domain name system (DNS), a simple mail transfer protocol (SMTP), a simple network management protocol (SNMP), a network file service (NFS), and a network information service (NIS).

Further, in the case that the terminal 20 includes a mobile terminal such as a smart phone, a tablet PC, personal digital assistants (PDAs), and a mobile communication terminal, the network may also include wireless networks such as a mobile communication network and a WiFi network

FIG. 2 is a flowchart shown a method for providing a game service in accordance with the present exemplary embodiment.

Referring to FIG. 2, the method for providing a game service in accordance with the present exemplary embodiment includes an event generating step S100 in which a game stop request event is generated by the terminal 20; a display control step S110 in which inquiry information for game control of the terminal 20 is controlled to be displayed to correspond to the game stop request event; and a game control step S120 in which the game of the terminal 20 is controlled based on manipulation information corresponding to the inquiry information.

When the game is an online game that is executable through a network, and is executed in the terminal 20 according to the control of the server 10, a method for providing a game service by the server 10 may be applied thereto.

However, when the game is mainly controlled by the terminal 20 like a stand-alone type of game or an online game in which the server 10 merely relays data, a method for providing a game service by the terminal 20 may be applied thereto.

The method for providing the game service by the server 10 will be described in detail. When a game stop command is inputted according to a user manipulation, for example, by pressing a game stop button during the execution of the game, the terminal 20 may determine that the game stop request event is generated (S100).

Once receiving the game stop request event from the terminal 20, the server 10 may control the game corresponding to the game stop request event to be temporarily stopped.

Then, the server 10 may transmit inquiry information corresponding to the game stop request event received from the terminal 20 thereto. The inquiry information may include information for confirming whether a game user wants to continue executing the game a little more or not, and may be displayed on a screen of the terminal 20 according to the control of the terminal 20 or the server 10 (S110). After the step S110, if it is finally determined that the game user does not want to continue executing the game based on manipulation information corresponding to the inquiry information, the server 10 controls the game to be stopped in the terminal 20 (S120).

If it is determined that the game user wants to continue playing the game based on the manipulation information corresponding to the inquiry information, the server 10 may control the game to be executed again in the terminal 20. Specifically, the server 10 may control the game to be executed from the stopped state by releasing the temporarily stopped state, or may control an initial screen to be displayed to re-start the game therefrom.

For easy description, the method for providing a game service in accordance with the present exemplary embodiment is described to be performed in the order as shown in FIG. 2, but performance procedure of each step may be changed, two or more steps may be combined, or one step may be divided into two or more steps without departing from the essential characteristics.

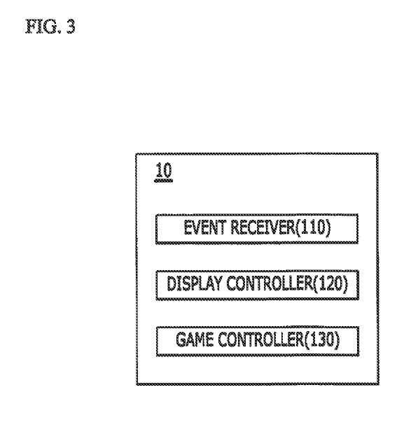

FIG. 3 is a block diagram showing the structure of a server for providing a game service in accordance with the present exemplary embodiment.

Referring to FIG. 3, the server 10 for providing a game service in accordance with the present exemplary embodiment includes an event receiver 110 for receiving a game stop request event generated by the terminal 10; a display controller 120 for controlling inquiry information for game control of the terminal 20 to be displayed on the terminal 20 to correspond to the received game stop request event; and a game controller 130 for receiving manipulation information corresponding to the inquiry information from the terminal 20 and controlling the game in the terminal 20.

The event receiver 110 may receive the game stop request event from the terminal 20, and may receive inquiry information request information corresponding to the game stop request event.

The display controller 120 controls inquiry information for game control in the terminal 20 to be displayed on the terminal 20. The inquiry information is set according to a user input to correspond to user information of the terminal 20, or includes pop-up contents information that is set by a server 10.

The pop-up contents information serves as information that is displayed on the screen of the terminal 20 to persuade the game user not to quit the game and continue playing the game, which corresponds to user information related to the game user who plays the game through the terminal 10. The pop-up contents information may be generated based on at least one of performance history information of the game or social information of the game, and may specifically include game assets such as experience values, game moneys, and items acquired while the game is executed by the game user; kinds, contents, and achievement rates of missions given to users, and the like.

The performance history information may include a time at which the user plays the game; game moneys, items, experience values, completed missions (may correspond to a quest in a general online game), and ongoing missions which are acquired from when the game is executed to when the game stop request event is received; position information at a virtual map at which the game is executed; various information, such as movement history information, related to operations made in the game from when the game is executed to when the game stop request event is received.

The game controller 130 controls the performance of the game to enable the user to enjoy the game in the terminal 20, and receives manipulation information corresponding to the inquiry information from the terminal 20 to control the game in the terminal 20.

A server for providing a game service in accordance with another exemplary embodiment may control information that is to be displayed as the pop-up contents information to be directly set by the user, or may select users whose terminals are required to display the pop-up contents information thereon and control the pop-up contents information to be displayed on only the terminals of the selected users.

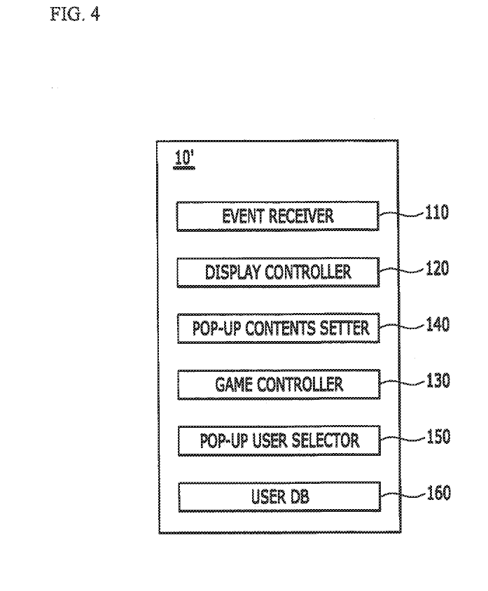

FIG. 4 is a block diagram showing the structure of the server for providing a game service in accordance with the exemplary embodiment.

Referring to FIG. 4, similarly to the case of FIG. 3, the server 10′ for providing a game service includes an event receiver 110, a display controller 120, and a game controller 130. The main operations of the event receiver 110, the display controller 120, and the game controller 130 are similar to those described with reference to FIG. 3, and thus the detailed descriptions thereof will be omitted.

The server 10′ for providing a game service in accordance with the present exemplary embodiment may further include a pop-up contents setter 140 for controlling pop-up contents information to be set; and a pop-up user selector 150 for selecting users whose terminals are required to display the pop-up contents information thereon.

The server 10′ of the present exemplary embodiment may further include a user DB 160 for storing user information of each user who uses the game service, i.e., account information, or game performance information such as performance history information and social information which respectively correspond to the account information.

The pop-up contents setter 140 may set which kind of pop-up contents information, i.e., what contents as the pop-up contents information included in the inquiry information is supplied to the terminal 20. For example, the pop-up contents setter 140 may set the pop-up contents information based on social information of the user or performance history information generated as the user executes the game.

For example, the pop-up contents setter 140 may set experience value information acquired by a user based on, e.g., performance history information of the user from when the game is executed by the user to when the game stop request event is received, as the pop-up contents information. When the experience value information is set as the pop-up contents information, the game controller 130 may acquires experience value information from performance history information corresponding to the user account of the terminal 20, from the user DB 160, and the acquired experience value information may be transferred to the terminal 20 as pop-up contents information and displayed on the screen of the terminal 20 according to the control of the display controller 120.

The pop-up contents setter 140 may set, as pop-up contents information, at least one of various items (e.g., experience values, items, missions, and the like) included in the game performance information as well as the aforementioned experience value information.

Pop-up contents may be set by the user or the terminal 20 or a manager of the server 10. The following descriptions focuses on the case that the user of the terminal 10 sets the pop-up contents displayed to correspond to a game stop request of the user.

The pop-up contents setter 140 may form a pop-up setting interface through which the user of the terminal 10 can set the pop-up contents information. The pop-up setting interface formed by the pop-up contents setter 140 may be displayed on the screen of the terminal 20 or the server 10 through the display controller 120.

At least one item that is settable as the pop-up contents information may be displayed in the pop-up setting interface. Once the user of the terminal 10 selects at least one of the displayed items, corresponding selection information may be transferred to the pop-up contents setter 140.

The pop-up contents setter 140 may generate pop-up contents information based on the transferred selection information. As the generated pop-up contents information is transferred to the game controller 130, information corresponding to the pop-up contents information may be displayed on the terminal 20 as the pop-up contents information.

The pop-up user selector 150 may generate user selecting information by selecting a user whose terminal is required to display the pop-up contents information thereon, and may transfer the generated user selecting information to the game controller 130.

As a result, the server for providing a game service in accordance with present exemplary embodiment may control the pop-up contents information to be displayed on the terminals pertaining to only some of the users using the game service.

Specifically, the pop-up user selector 150 may determine whether pop-up contents information is displayed on the terminal pertaining to a corresponding user based on a predetermined pop-up display rule. For example, when whether “the remaining experience value until a next level is equal to or smaller than 50 xp” is set as the pop-up display rule, the pop-up user selector 150 may determine whether to satisfy the pop-up display rule that “the remaining experience value until a next level is equal to or smaller than 50 xp” by acquiring, from the user DB 160, game performance information corresponding to user information of the terminal that transmits the game stop request information. Further, the pop-up user selector 150 may generate selection information including user information of a user whose terminal is determined as a corresponding terminal and transfer the generated selection information to the game controller 130.

The game controller 130 may identify each terminal corresponding to the user information included in the selection information based on the transferred the selection information. The display controller 120 may control the pop-up contents information to be displayed on only the identified terminals.

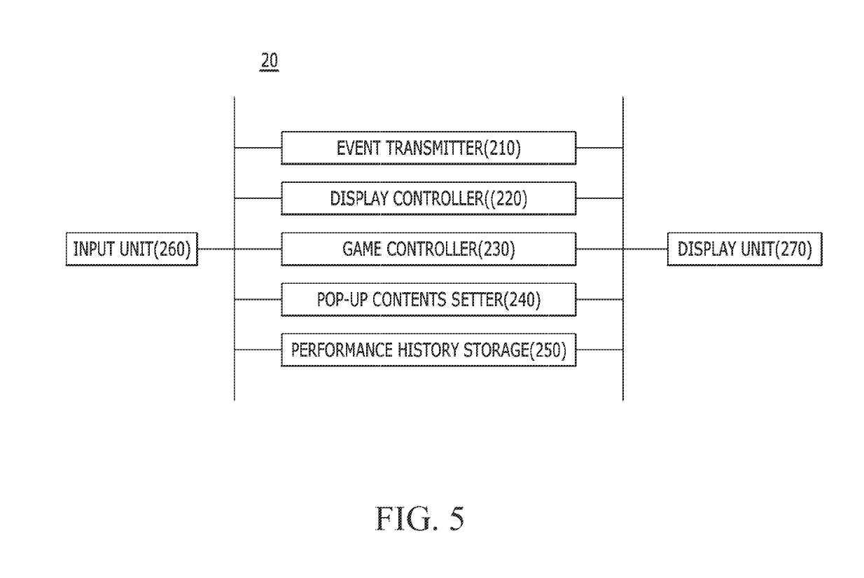

FIG. 5 is a block diagram showing the structure of a terminal for providing a game service in accordance with the present exemplary embodiment.

Referring to FIG. 5, the terminal 20 for providing a game service in accordance with the present exemplary embodiment includes an event transmitter 210 for transmitting a game stop request event that is generated according to a user manipulation, to the server 10; a display controller 220 for controlling inquiry information for controlling a game corresponding to the game stop request event to be displayed when the inquiry information is received; and a game controller 230 for controlling a game based on manipulation information corresponding to the inquiry information when the manipulation information is inputted.

The terminal 20 further includes an input unit 260 for receiving a manipulation command from a user; a display unit 270 for displaying the inquiry information; and a performance history storage 250 for storing game performance history information of a user of the terminal 20.

In the case that main operations or all operations of the game service are performed by the terminal 20. The terminal 20 may further include a pop-up contents setter 240 for setting kinds of pop-up contents information included in the inquiry information.

The pop-up contents setter 240 of the terminal 20 performs similar operations to those of the pop-up contents setter 140 of the server 10 described with reference to FIG. 4, the detailed descriptions thereof will be omitted

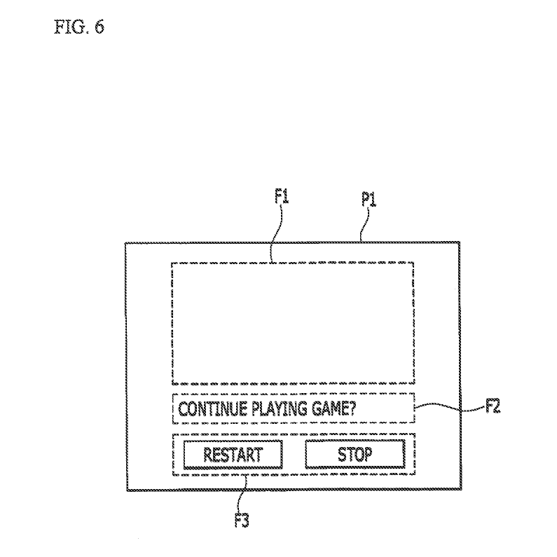

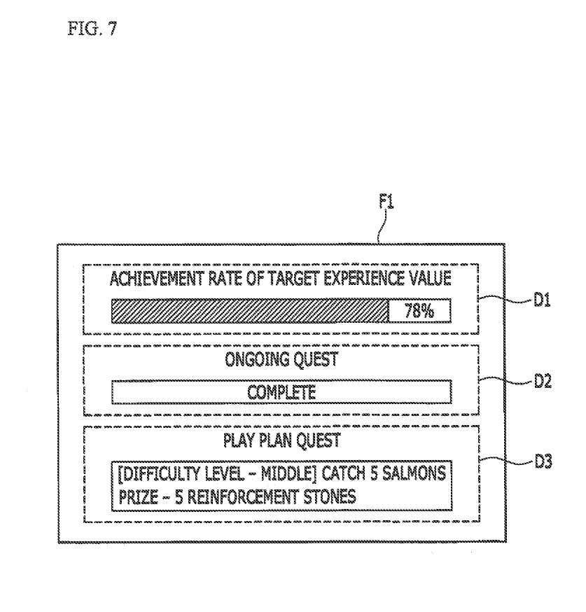

FIG. 6 to FIG. 8B are examples showing what is displayed on the screen of the terminal according to the method for providing a game service in accordance with the present exemplary embodiment. Specifically, FIG. 6 is an example showing how the inquiry information is displayed thereon in accordance with the present exemplary embodiment, and FIG. 7 is an example showing how the pop-up contents information is displayed thereon in accordance with the present exemplary embodiment

Referring to FIG. 6, when a game stop request event is generated through the input unit 260 of the terminal 10, the terminal 20 for providing a game service in accordance with the present exemplary embodiment may display an inquiry information display window P1 on a screen of the display unit 270 of the terminal 20.

The inquiry information display window P1 may be embodied to include a pop-up information display region F1 for displaying pop-up contents information thereon; a message display region F2 for displaying a message that is required to report to the user through the inquiry information display window P1; and a command display region F3 for displaying a functional button for receiving a command for game stop or game restart.

Accordingly, when the inquiry information display window P1 is displayed, the user may check information displayed at the pop-up information display region F1 and the message display region F2, and may select and input one of the re-start button or the stop button at the command display region F3 based on the checked information. For example, when the re-start button is selected and inputted through the input unit 260 of the terminal 20, the game controller 230 or 130 of the terminal 20 or the server 10 may release the temporarily stopped game and control the game to be continuously executed.

In contrast, when the stop button is selected and inputted through the input unit 260 of the terminal 20, the game controller 230 of the terminal 20 may transmit the result that a final game stop command is inputted from the user, to the server 10. Accordingly, the game controllers 230 and 130 of the terminal 20 and the server 10 control the game to be stopped.

Referring to FIG. 7, the pop-up contents information that is set according to the user manipulation may be displayed on the pop-up information display region F1.

The display controller 220 or 120 of the terminal 20 or the server 10 may divide the pop-up information display region F1 into three regions. For example, as shown in FIG. 7, when information of a target achievement rate for an experience value, ongoing quest information, and play plan quest information are set as the pop-up contents information, the display controller 220 or 120 of the terminal 20 or the server 10 may divide the pop-up information display region F1 into three display regions D1, D2, and D3 to control the pop-up contents information to be respectively displayed on the display regions D1, D2, and D3

When the information of a target achievement rate for an experience value is set as pop-up contents information by the server 10, the game controller 130 of the server 10 may check the experience value acquired during the execution of the game, from the performance history information of the corresponding user stored in the user DB 160, and may calculate the achievement rate based on a predetermined promotion experience value that is required to be promoted to a next level and the checked acquired experience value. Further, the game controller 130 of the server 10 may transmit information related to the calculated achievement rate to the terminal 20 as pop-up contents information, and the game controller 230 of the terminal 20 may control the received achievement rate information to be displayed on the screen of the terminal 20 through the display controller 220.

When the information of a target achievement rate for an experience value is set as pop-up contents information by the terminal 20 instead of the server 10, the game controller 230 of the server 10 may check the experience value acquired during the execution of the game, from the performance history information of the user stored in the performance history storage 250, and may calculate the achievement rate based on a predetermined promotion experience value that is required to be promoted to a next level and the checked acquired experience value. Further, the game controller 230 may control the calculated achievement rate information to be displayed on the screen of the terminal 20 through the display controller 220.

Similarly to the aforementioned method, when the ongoing pop-up contents information is set by the server 10, the game controller 130 of the server 10 may check execution information of the ongoing quest of a corresponding user from the performance history information of the user stored in the user DB 160. The game controller 130 may calculate a quest achievement rate or determine a currently executed step from the checked quest execution information and transmit the calculated or determined result to the terminal 20 as pop-up contents information. Further, the game controller 230 of the terminal 10 may control the received information to be displayed on the screen of the terminal 20 through the display controller 220.

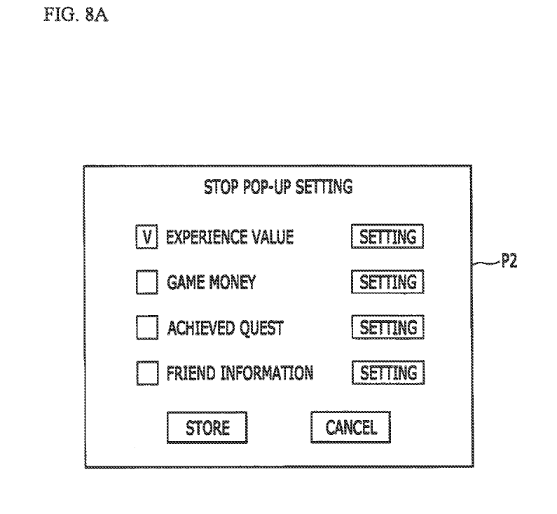

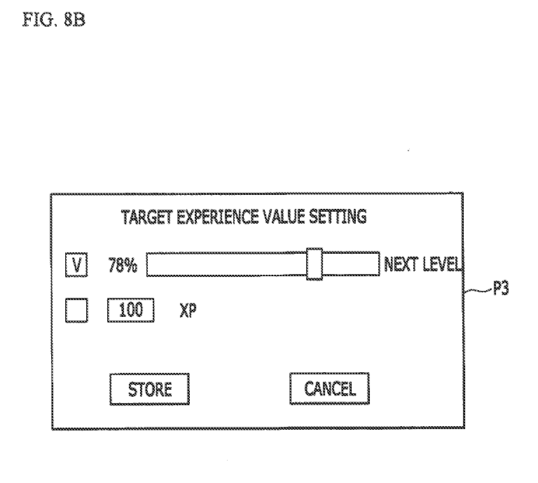

FIG. 8A and FIG. 8B are show an example of a pop-up setting interface embodied in accordance with the present exemplary embodiment.

In the system for providing a game service in accordance with the present exemplary embodiment, the pop-up contents setter 140 or 240 of the server 10 or the terminal 20 may form the pop-up setting interface, and the pop-up setting interface may be displayed on the screen of the server 10 or the display unit 270 of the terminal 10.

Referring to FIG. 8A, the pop-up setting interface may display various displayable items as pop-up contents information based on social information or game performance information corresponding to user information of the terminal 20, and the user may select an item of desired information from among the displayed items through the input unit 260 when the game stop request event is generated.

Detailed contents of the selected item as the pop-up contents information may be set. For example, as shown in FIG. 8A, when an “experience value” item is selected and the corresponding “setting” item is selected, detailed information desired to be checked for the experience value item may be set as shown in FIG. 8B.

Referring to FIG. 8B, when a selection event for the setting button, the pop-up setting interface, the user may set a target value desired to be achieved during the execution of the game.

Specifically, the user may set a target value desired to be achieved from when accessing a game service server to start playing the game to when generating the game stop request event, through the pop-up setting interface.

For example, as shown in FIG. 8B, when the pop-up contents are set as acquiring the experience value of 78% for the promotion experience value required to be promoted to a next level through the input unit 260 and the pop-up setting interface, the game controller 130 or 230 may calculate an achievement rate for the target experience value based on a promotion experience value and the experience value acquired by the user before the user generates the game stop request event. The game controller 130 or 230 may transmit information related to the calculated achievement rate for the target experience value to the display controller 140 or 240 as pop-up contents information, and the target experience value that is preset by a user manipulation and the corresponding achievement rate for the target experience value to be displayed together on the inquiry information window.

In the meantime, the experience value acquired by the user may be higher than the preset target experience value of the user. In this case, the display controller 140 or 240 may display the target experience value preset by the user as being achieved by 100% on the pop-up contents display region of the inquiry information. However, in consideration of the object for persuading the user who is desired to quit the game to continue playing the game, the game controller 130 or 230 may control the achievement rate for the target experience value not to be displayed when the target experience value is determined to be achieved by 100% or more.

Further, when the experience value acquired by the user before generating the game stop request event is equal to or higher than the preset target experience of the user, that is, the target experience value is achieved, the game controller 130 or 230 may control a prize designed to be supplied to the corresponding user to be supplied thereto. As a result, when the game stop request event is generated, the game controller 130 and 230 may calculate the experience value acquired by the user from the game execution until the game stop request event is generated and, if the calculated experience value is determined to be equal to or higher than the target experience preset by the user, may supply a predetermined experience value, game money, or item as the prize to the user.

Accordingly, the user may check the target experience value preset by the user before quitting the game, and thus the desire to achieve the target experience value may be stimulated. When the target experience value is achieved, the user may acquire the corresponding prize. As a result, it is possible to maintain the interest in the game and persuade the user to play the game more enthusiastically.

The method for providing a game service in accordance with the exemplary embodiments as described above may be executed by the applications basically installed in the terminal (including programs included in a platform, an operating system, or the like which are basically installed in the terminal), and may also be executed by the applications (i.e., programs) which are directly installed in the terminal by the user via an application store server or an application store server such as a web server associated with the applications or the corresponding services. Herein, the operating system of the terminal 20 may be an operating system such as Window or Macintosh for a general personal computer such as a desk top computer or a mobile operating system such as OS or Android for a smart phone or a tablet PC.

In this respect, the method for providing a game service in accordance with the exemplary embodiments may be implemented by the applications (i.e., programs) which are basically installed or directly installed by the user in the terminal and may be recorded in a computer readable recording medium of the terminal, and the like

The program implementing the method for providing a game service in accordance with the exemplary embodiments executes the function of performing a control to extract the character attribute information on the first character, the function of performing a control to generate the transfer character attribute information based on the extracted character attribute information on the first character, and the function of performing a control to update the character attribute information on the second character by referring to the transfer character attribute information

In addition, it is possible to execute all functions corresponding to the aforementioned method for providing a game service in accordance with the exemplary embodiment by referring to FIG. 2 to FIG. 6

The programs are recorded in the computer readable recording medium and are executed by the computer, such that the above-mentioned functions may be executed

As described above, in order for the computer to read the programs recorded in the recording medium and execute the method for providing the function of transferring character attribute information in the game implemented by the programs, the above-mentioned programs may include codes which are coded with computer languages such as C, C++, JAVA, machine language, and the like which may be read by a processor (CPU) of the computer.

The code may include a function code associated with a function of defining the above-mentioned functions and may also include an execution procedure related control code required for the processor of the computer to execute the above-mentioned functions according to a predetermined procedure.

Further, the code may further include a memory reference related code indicating at which location (address number) of the memory inside or outside the computer additional information or media required for the processor of the computer to execute the above-mentioned functions need to be referenced.

Further, in order for the processor of the computer to execute the above-mentioned functions, when the processor needs to communicate with any other computers or servers, etc. at a remote location, the code may further include a communication related code about how the processor of the computer communicates with any other computers or servers at a remote location or which information or media the processor of the computer transmits and receives at the time of the communication, by using the communication module (for example, wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

Hereinabove, examples of a computer readable recording medium recorded with programs for performing the method for providing a game service in accordance with the exemplary embodiments as described above include a ROM, a RAM, a CD-ROM, a magnetic tape, a floppy disk, an optical media storage device, and the like

Further, a computer readable recording medium recorded with applications, which are programs for executing the method for providing a game service in accordance with the exemplary embodiments, may be a storage medium (for example, hard disk, and the like) included in an application store server or an application providing server such as a web server associated with applications or corresponding services, and the like, or the application providing server itself

A computer, which may read a recording medium recorded with applications that are programs for executing the method for providing a game service in accordance with the exemplary embodiments, may include not only a general PC such as a typical desktop and a laptop but also a mobile terminal such as a smart phone, a tablet PC, personal digital assistants (PDAs), and a mobile communication terminal, and is to be construed as all the computable devices

When a computer, which may read a recording medium recorded with applications that are programs for executing the method for providing a game service in accordance with the exemplary embodiments, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program

Hereinabove, although it has been mentioned that all components configuring the exemplary embodiment described hereinabove are combined with each other as one component or are combined and operated with each other as one component, the present invention is not necessarily limited to the above-mentioned exemplary embodiment. That is, all the components may also be selectively combined and operated with each other as one or more component without departing from the scope of the present invention. In addition, although each of all the components may be implemented by one independent hardware, some or all of the respective components which are selectively combined with each other may be implemented by a computer program having a program module performing some or all of functions combined with each other in one or plural hardware. The codes and the code segments configuring the computer program may be easily inferred by a person having ordinary skill in the art to which the present invention pertains. The computer programs are stored in the computer readable media and are read and executed by the computer and may implement the exemplary embodiment. As the storage medium of the computer programs, a magnetic recording medium, an optical recording medium, and the like may be used.

Further, it will be further understood that the terms “comprises” or “have” used in this specification may include the corresponding components unless explicitly described to the contrary and therefore, do not preclude other components but further include the components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as the same meanings as meanings within a context of the related art and should not be interpreted as ideally or excessively formal meanings unless clearly defined in the present specification.

The spirit of the present invention has been just exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims and it should be interpreted that all spirits equivalent to the following claims fall within the scope of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a game service, the method comprising:
generating an event in which a game stop request event is generated by a terminal;
controlling a display in which inquiry information for game control of the terminal is controlled to be displayed to correspond to the game stop request event; and
controlling a game in which a game of the terminal is controlled based on manipulation information corresponding to the inquiry information.

2. The method of claim 1, wherein the inquiry information corresponding to user information of the terminal includes pop-up contents information that is set by a server or a user input.

3. The method of claim 2, wherein the pop-up contents information is generated based on at least one of performance history information of the game or social information of the game.

4. The method of claim 2, further comprising,
before generating the event,
setting a pop-up in which a pop-up setting interface is controlled to be displayed to enable a user to select an item to be displayed as the pop-up contents information.

5. The method of claim 2, wherein, in controlling the display, the pop-up contents information is controlled to be displayed on the terminal of a user selected according to a predetermined pop-up display reference.

6. A server for providing a game service, the server comprising:
an event receiver configured to receive a game stop request event that is generated by a terminal;
a display controller configured to control inquiry information for game control of the terminal to be displayed to correspond to the received game stop request event; and
a game controller configured to receive manipulation information corresponding to the inquiry information from the terminal to control a game of the terminal.

7. The server of claim 6, further comprising
a pop-up contents setter configured to form a pop-up setting interface for enabling a user to select an item to be displayed among items corresponding to user information of the terminal as pop-up contents information included in the inquiry information.

8. The server of claim 6, further comprising
a pop-up user selector configured to select users whose terminals are required to display thereon pop-up contents information included in the inquiry information according to a predetermined pop-up display rule.

9. A method for providing a game service by a terminal, the providing method comprising:
generating an event in which a game stop request event that is generated according to a user manipulation is transmitted to a server;
controlling a display in which inquiry information for game control corresponding to the game stop request event is controlled to be displayed when the inquiry information is inputted; and
controlling a game in which a game is controlled based on manipulation information that is inputted to correspond to the inquiry information.

10. A terminal for providing a game service, the terminal comprising:
an event transmitter configured to transmit a game stop request event that is generated according to a user manipulation to a server;
a display controller configured to control inquiry information for game control corresponding to the game stop request event to be displayed when the inquiry information is inputted; and
a game controller configured to control a game based on manipulation information that is inputted to correspond to the inquiry information.

11. A computer readable recording medium recorded with a program for executing a method for providing a game service by a terminal,
wherein the program implements:
a function for transmitting a game stop request event that is generated according to a user manipulation to a server;
a function for controlling inquiry information for game control corresponding to the game stop request event to be displayed when the inquiry information is inputted; and
a function for controlling a game based on manipulation information that is inputted to correspond to the inquiry information.

12. A computer readable recording medium recorded with a program for executing a method for providing a game service,
wherein the program implements:
a function for allowing a game stop request event to be generated by a terminal;
a function for controlling inquiry information for game control of the terminal to be displayed to correspond to the game stop request event; and
a function for controlling a game of the terminal based on manipulation information corresponding to the inquiry information.
